(19) United States
(12) Patent Application Publication
(10) Pub. No.: US 2003/0177404 A1
(43) Pub. Date: Sep. 18, 2003

(54) Power distribution control system and method for limiting transient current conditions in computer architectures

(76) Inventors: Joel A. Jorgenson, Fargo, ND (US); John W. McCullough, Ft. Myers, FL (US); William J. Steingrandt, Punta Gorda, FL (US)

Correspondence Address: WESTMAN, CHAMPLIN & KELLY, A PROFESSIONAL ASSOCIATION, INTERNATIONAL CENTRE-SUITE 1600, 900 SECOND AVENUE SOUTH, MINNEAPOLIS, MN, 55402-3319, US

(21) Appl. No.: 10/099,456

(22) Filed: Mar. 14, 2002

(51) Int. Cl. G06F 1/26

(52) U.S. Cl. 713/300

(57) ABSTRACT

A power distribution control system for high speed electronics limits peak transient current when entering or exiting circuitry into or out of a system wide freeze mode. The power distribution control system includes power supply circuitry which provides a first supply voltage on a first output line. Multiple circuitry sections are each coupled to and powered by the power supply circuitry. While in the system wide freeze mode, each of the multiple circuitry sections is held inactive by a corresponding one of multiple control signals. A freeze controller is coupled to each of the circuitry sections, and provides the corresponding control signal to each circuitry section. The control signal provided to each particular circuitry section causes the particular circuitry section to enter or exit the system wide freeze mode independently of others of the multiple circuitry sections. The freeze controller is configured to generate the control signals to cause each of the circuitry sections to enter or exit the system wide freeze mode while limiting peak transient current provided by the power supply circuitry to the circuitry sections to below a predetermined value.

### BACKGROUND OF THE INVENTION

The present invention relates to computer systems. More particularly, the present invention relates to power distribution control systems for high speed electronics which control entering and exiting of circuitry sections into and out of a system wide freeze mode.

With advances in semiconductor and other high speed electronics commonly used in computer systems, operational clock frequencies are increasing. Further, supply or rail voltages used to power the high speed electronics are decreasing. Currents provided by the power supply circuitry are also necessarily increasing.

In electronic systems, the power distribution system typically includes two principle components: a voltage regulatory system (consisting of active circuitry), and a matrix of capacitive elements. As high speed circuits switch, power to the integrated circuits are first supplied by the capacitive elements, and the capacitors are recharged by the voltage regulatory system. Power supply systems are becoming increasingly difficult to design for use in high speed systems, since the transient current demands are exceeding capabilities.

A traditional approach is to create a power distribution system of capacitors that can provide charge while the integrated circuits are switching. This approach is rapidly loosing effectiveness, as higher frequencies, reduced supply voltages, and larger current demands are creating conditions that existing technologies and architectures cannot meet. Table 1 shown below illustrates the demand on the power distribution system in electronic systems, in terms of system parameters, which are estimated from the year 1990 through the year 2002.

TABLE 1

| | | power | | | |
|---|---|---|---|---|---|
| | | dis. | | | |
| year | Volt. | (watts) | current | Ztarget | Freq. |
| 1990 | 5.0 | 5 | 1 | 250 | 16 |
| 1993 | 3.3 | 10 | 3 | 54 | 66 |
| 1996 | 2.5 | 30 | 12 | 10 | 200 |
| 1999 | 1.8 | 90 | 50 | 1.8 | 600 |
| 2002 | 1.2 | 180 | 150 | 0.4 | 1200 |

The transient current demands on a power supply system are most severe as components are exiting “freeze” modes. A freeze mode is defined to be the condition where the circuitry is held to an inactive state independent of transitioning inputs or selections. The freeze mode may be a reset state, where all circuitry is driven to a defined state of operation, or a sleep state, where the circuitry is suspended from its operation. The reset state and sleep state forms of freeze modes may also be denoted as cold reset states and warm reset states. A system wide freeze mode is a mode of operation in which all circuit sections, sub-circuits for modules are in a freeze mode at the same time. Freeze modes are generally used either on the application of system power when the computer is first started, or upon a signal dictating that the system needs to leave a lower power mode. Transient current demand when entering a system wide sleep mode can also potentially be severe.

When entering or exiting a system wide freeze mode, the peak transient current which must be supplied by the power supply circuitry sometimes exceeds a maximum value. If the demand for electronic charge exceeds the capability of the power supply circuitry, including the above-mentioned capacitors, the integrity of the system is compromised and system interruption or failure can result. Typically, this results in a system fault, or reset in certain cases. This is becoming a significant problem in computers, particularly in laptop systems. These peak transient current related errors can occur both when entering the system wide sleep mode, and while releasing or exiting the system wide free mode.

In order to address the demand of higher power consumption, a variety of power saving techniques have been utilized. This is particularly true in laptop and other computers which are powered from a battery. One method of reducing power consumption in a computer system is disclosed by Ignatius Tjandrasuwita in U.S. Pat. No. 6,212,645 entitled “PROGRAMMABLE AND FLEXIBLE POWER MANAGEMENT UNIT.” In the power management unit disclosed by Tjandrasuwita, the power management unit supports five different power states: a normal power state, a software-controlled sleep power state, a hardware-controlled sleep power state and two register programmable power states. In the different sleep power states, different sub-circuits, modules or circuitry sections are placed into a sleep mode in order to reduce power consumption. Generally, in a sleep mode or state, the clock signal is disabled for the particular circuitry sections in order to reduce power consumption. However, even with the clock signal disabled, in some sleep modes the circuit elements maintain their logic states during the sleep mode, which requires that the capacitors or other elements receive refresh currents to maintain the data states. Further, while power distribution systems known to the inventors are designed to reduce overall power consumption, they do not address the problems associated with peak transient currents when entering or exiting a system wide sleep mode.

Consequently, a power distribution control system for high speed electronics, such as computer systems, which overcomes one or more problems associated with peak transient currents exceeding an acceptable limit value during transitions into or out of a system wide sleep mode, would be a significant improvement in the art.

### SUMMARY OF THE INVENTION

A power distribution control system for high speed electronics limits peak transient current when entering or exiting circuitry into or out of a system wide freeze mode. The power distribution control system includes power supply circuitry which provides a first supply voltage on a first output line. Multiple circuitry sections are each coupled to and powered by the power supply circuitry. While in the system wide freeze mode, each of the multiple circuitry sections is held inactive by a corresponding one of multiple control signals. A freeze controller is coupled to each of the circuitry sections, and provides the corresponding control signal to each circuitry section. The control signal provided to each particular circuitry section causes the particular circuitry section to enter or exit the system wide freeze mode independently of others of the multiple circuitry sections. The freeze controller is configured to generate the control signals to cause each of the circuitry sections to enter or exit the system wide freeze mode while limiting peak transient current provided by the power supply circuitry to the circuitry sections to below a predetermined value.

### BRIEF DESCRIPTION OF THE DRAWINGS

FIG. 1A is a block diagram illustrating a power distribution control system for high speed electronics in accordance with some embodiments of the present invention.

FIG. 1B is a block diagram illustrating a power distribution control system as shown in FIG. 1A, but with the power supply circuitry providing multiple supply voltages for powering the multiple circuitry sections.

FIG. 2 is a block diagram illustrating portions of the power distribution control system shown in either of FIGS. 1A or 1B, including multiple circuitry sections and a transient current limiting freeze controller, in accordance with embodiments of the present invention.

FIG. 3 is a block diagram illustrating a first more particular embodiment of the portions of the power distribution control system shown in FIG. 2.

FIG. 4 is a block diagram illustrating a second more particular embodiment of the power distribution control system shown in FIG. 2.

FIG. 5 is a block diagram illustrating a third more particular embodiment of the power distribution control system shown in FIG. 2.

### DETAILED DESCRIPTION OF THE PREFERRED EMBODIMENTS

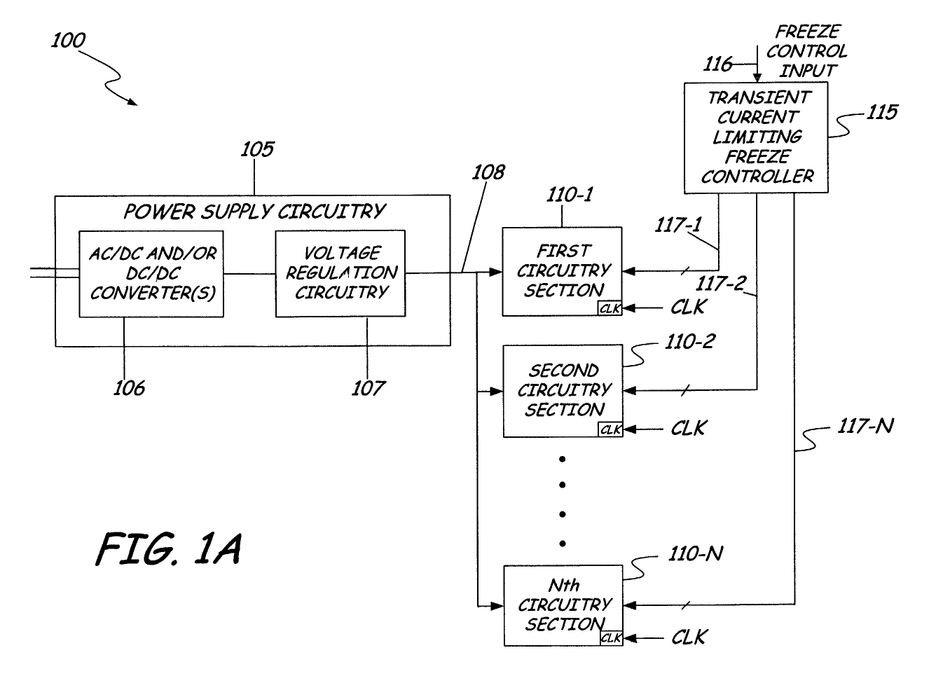

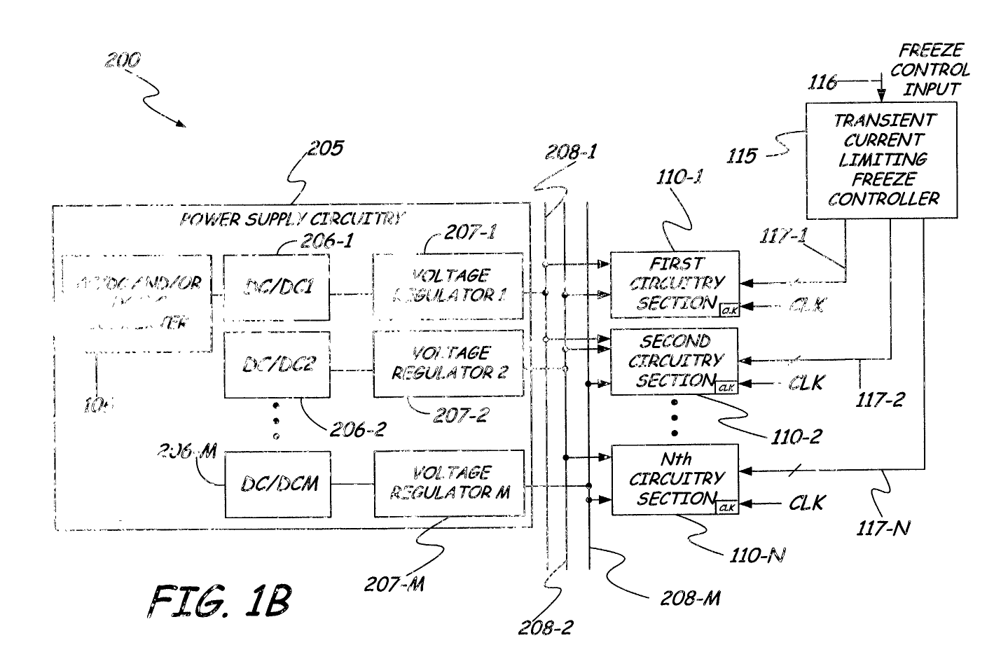

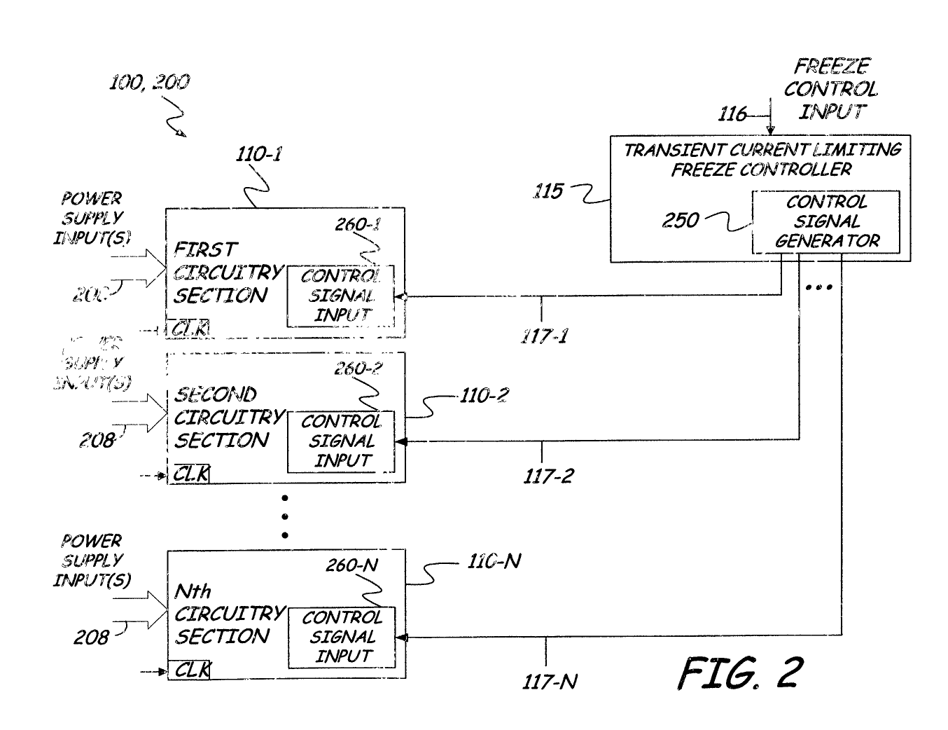

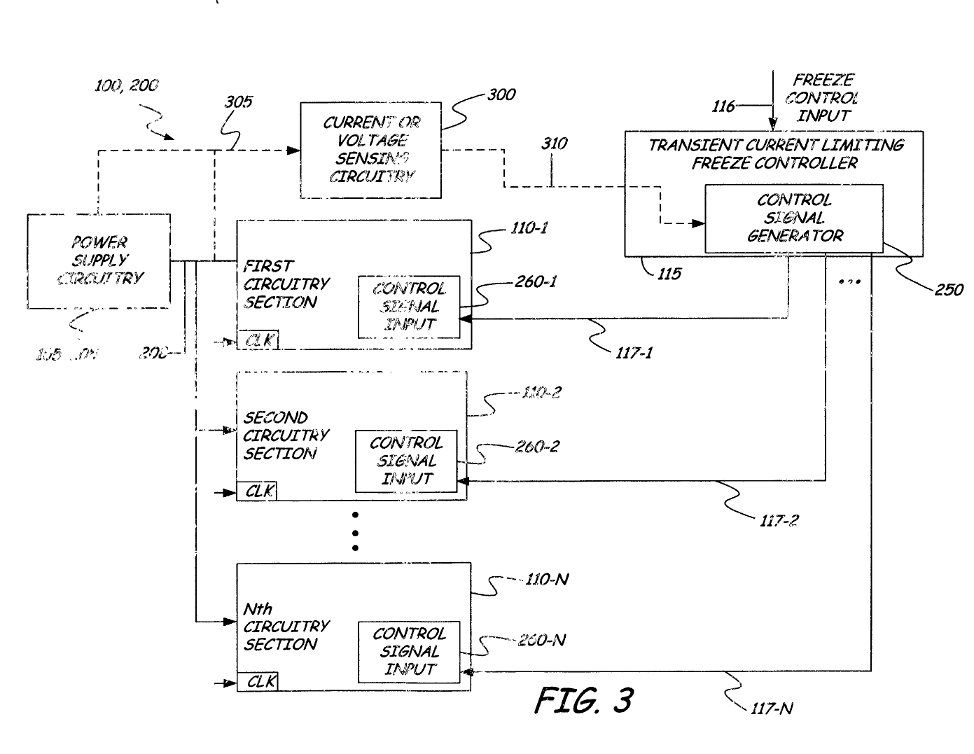

The present invention includes a power distribution control system for high speed electronics which limits peak transient current when multiple circuitry sections are entering into or exiting out of a system wide freeze mode. FIGS. 1A, 1B and 2 illustrate the general concept of the power distribution control system of the present invention. FIGS. 3-5 illustrate three more particular embodiments of the power distribution control system of the present invention.

Referring now to FIG. 1A, shown is power distribution control system 100 in accordance with embodiments of the present invention. Power distribution control system 100 includes power supply circuitry 105 providing a first supply voltage on a first output line 108. As illustrated, the power supply circuitry 105, includes AC/DC and/or DC/DC converter(s) for converting an input voltage from a first type or magnitude (i.e., AC-to-DC or DC-to-DC step-down conversion) to a second type or magnitude, and voltage regulation circuitry 107 which is used to provide a stable supply voltage under differing load conditions.

Multiple circuitry sections, sub-circuits or modules (collectively referred to herein as “circuitry sections”) 110 are also included in system 100. The multiple circuitry sections (circuitry sections 110-1 through 110-N are shown) are each coupled to and powered by power supply circuitry 105, for example via output line 108 and/or via multiple output lines. While system 100 is in a system wide freeze mode, each of the N circuitry sections 110 is held in active in a freeze mode by a corresponding control signal (117-1 through 117-N) provided by transient current limiting freeze controller 115. Freeze controller 115 receives a freeze control input 116, for example of the type provided by a user input or a separate system. Freeze control input 116 causes freeze controller 115 to either enter each of the circuitry sections into a system wide freeze mode, or to exit each of the circuitry sections out of a system wide freeze mode. As will be discussed below in greater detail, freeze controller 115 generates control signals 117-1 through 117-N in order to cause the circuitry sections 110 to enter or exit the system wide freeze mode independently of each either. By separately controlling each of the multiple circuitry sections as it enters or exits the system wide freeze mode, the peak transient current provided by the power supply circuitry can be limited to an acceptable and predetermined value.

FIG. 1B is a block diagram, illustrating power distribution control system 200 in accordance with alternate embodiments of the present invention. Power distribution control system 200 shown in FIG. 1B differs from power distribution control system 100 shown in FIG. 1A only in that power supply circuitry 205 shown in FIG. 1B includes components which provide multiple different supply voltages on multiple different output lines 208 (output lines 208-1 through 208-M are shown). For example, power supply circuitry 205 includes AC/DC and/or DC/DC converter 106 as was included in power supply circuitry 105. However, power supply circuitry 205 further includes multiple DC/DC converters (206-1 through 206-M) in order to provide M different DC supply voltages, as may be required to power different types of components in different circuitry sections. Consequently, power supply circuitry 205 also includes multiple voltage regulators or regulation circuitry (207-1 through 207-M), each of which provide the function of voltage regulation circuitry 107 shown in FIG. 1A, but for the different supply voltages.

The concepts of the present invention apply equally to either the power supply circuitry 105 shown in FIG. 1A or the power supply circuitry 205 shown in FIG. 1B. Further, the concepts of the invention can also be applied to power distribution control systems which use other types of power supplies. Therefore, discussions of the power distribution control system of the present invention made with reference to FIGS. 2-5 are intended to be of a general nature and are not intended to be limited to a particular power supply design.

FIG. 2 is a block diagram illustrating portions of power distribution control systems 100 and/or 200 in greater detail. As shown in greater detail in FIG. 2, transient current limiting freeze controller 115 includes a control signal generator 250. Control signal generator 250 generates multiple control signals 117 (117-1 through 117-N) are shown) for controlling each of the N circuitry sections 110 independently of the other circuitry sections. Each of circuitry sections 110 includes a corresponding control signal input 260 (260-1 through 260-N) which is coupled to control signals generator 250 via a control line in order to receive its corresponding control signal. Using control signal 117, control signal generator 250 of freeze controller 115 controls the entry into, or exit from, a system wide sleep mode in a manner which limits the peak transient current provided by the power supply to the circuitry sections. FIGS. 3-5 illustrate three alternate embodiments which show in greater detail techniques used to transition into and out of a system wide freeze mode while limiting the peak transient current to a level which will not cause a system fault or other errors.

FIG. 3 is a block diagram illustration of portions of power distribution control systems 100 and/or 200, showing additional features in accordance with the first more particular embodiment of the present invention. As shown in FIG. 3, the power distribution control systems of the present invention can include a current or voltage sensing circuit 300 coupled to power supply circuitry 105,205 via a connection 305. The connection 305 can be, for example, an electrical connection to the one or more output lines 208 from power supply circuitry 105,205 on which one or more supply voltages are provided. In the alternative, connection 305 can be to other portions of power supply circuitry 105,205.

Current or voltage sensing circuitry 300 senses a current or a voltage provided by the power supply circuitry, and in response generates a sensed output signal 310 indicative of the sensed current or voltage provided by the power supply circuitry. In response to the freeze control input 116, control signal generator 250 generates the individual control signals 117 based upon the sensed output signal 310 in order to limit peak transient current provided by the power supply circuitry. Thus, control signal generator 250 or freeze controller 115 can sense when the current or voltage provided by the power supply circuitry has sufficiently recovered from a first circuitry section entering or exiting the system wide freeze mode, before initiating a second circuitry sections entry into or exit from the system wide freeze mode.

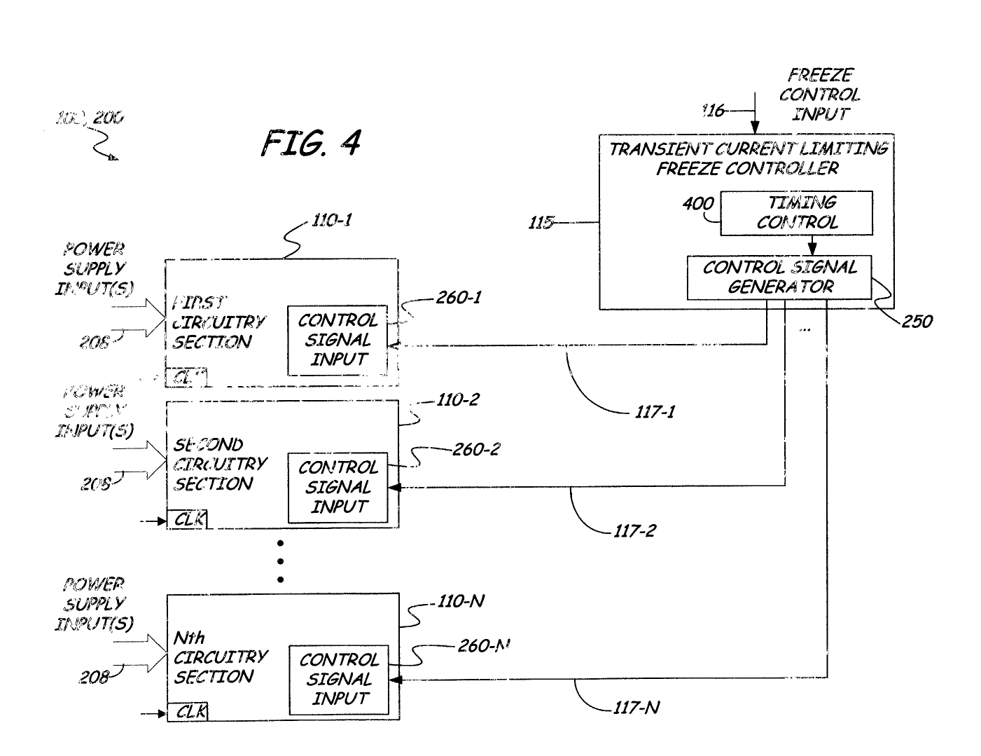

FIG. 4 is a block diagram which illustrates a second more particular embodiment of power distribution control system 100 and/or 200 in accordance with an alternate embodiment of the present invention. As shown in FIG. 4, freeze controller 115 can also include a timing circuit 400 coupled to the control signal generator 250. In response to the freeze control input 116, the timing circuit 400 controls the control signal generator 250 to sequentially enter each of the multiple circuitry section 100 into the system wide freeze mode, or to sequentially exit each of the multiple circuitry sections out of the system wide freeze mode, in order to limit peak transient current provided by the power supply circuit. The timing circuits allows the circuitry sections to enter or exit the system wide freeze mode with an appropriate delay between sections so that transient current conditions can recover to an acceptable level. In some embodiments, timing circuit 400 includes a state machine which controls the sequential entering or exiting of the individual circuitry sections into or out of the freeze mode.

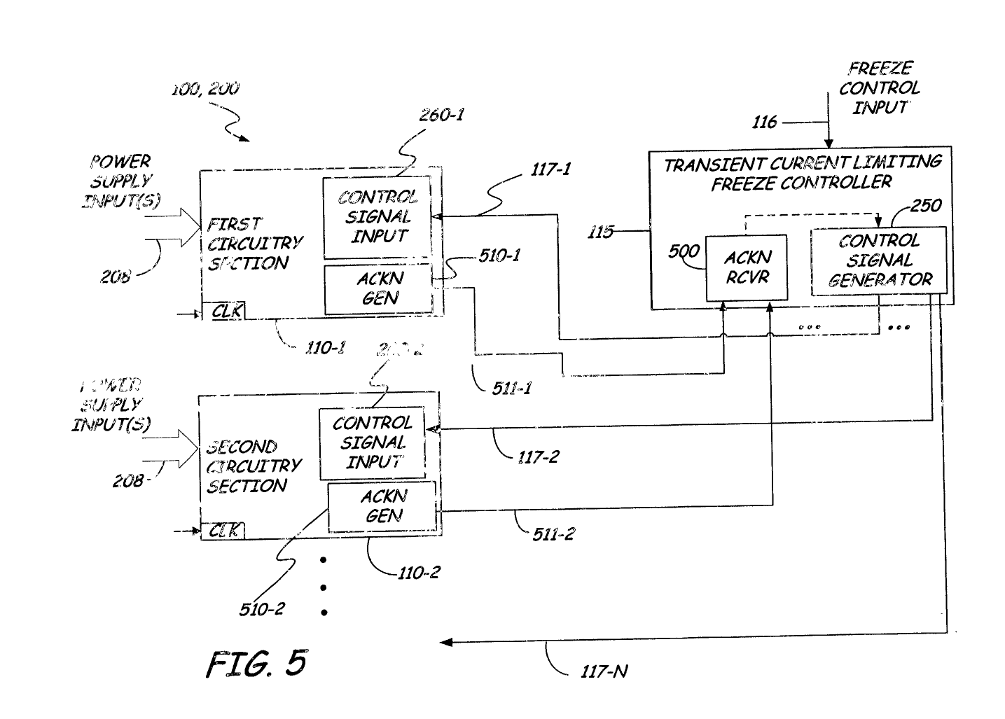

FIG. 5 illustrates, in block diagram form, another alternate embodiment of power distribution control system 100 and/or 200. As shown in FIG. 5, each of circuitry sections 110 includes an acknowledge generating circuit 510 (510-1 and 510-2 are shown). Each acknowledge generating circuit 510 generates an acknowledge signal 511 (511-1 and 511-2 are shown) once its particular circuitry section has entered into or exited out of the system wide sleep mode. Freeze controller 115 also includes an acknowledge receiving circuit 500 coupled to the acknowledge generating circuits 510 of each of the circuitry section 110. Freeze controller 115 controls the control signal generator 250 to enter or exit a next circuitry section into or out of the system wide freeze mode only after the previous circuitry section has acknowledged (via acknowledge generating circuit 510 and acknowledge signal 511) that it has entered or exited the system wide sleep mode. Thus, this alternative embodiment of power distribution control system 100 and/or 200 utilizes hand shaking between circuitry sections 110 and freeze controller 115 in order to limit the peak transient current when entering or exiting the system wide sleep mode.

Although the present invention has been described with reference to preferred embodiments, workers skilled in the art will recognize that changes may be made in form and detail without departing from the spirit and scope of the invention.

What is claimed is:

1. A power distribution control system for high speed electronics which limits peak transient current when entering or exiting circuitry into or out of a system wide freeze mode, the power distribution control system comprising:
power supply circuitry providing a first supply voltage on a first output line;
a plurality of circuitry sections each coupled to and being powered by the power supply circuitry, wherein while in the system wide freeze mode, each of the plurality of circuitry sections is held inactive by a corresponding one of a plurality of control signals;
a freeze controller coupled to and providing the corresponding control signal to each of the plurality of circuitry sections, the control signal provided to each particular circuitry section causing the particular circuitry section to enter or exit the system wide freeze mode independently of others of the plurality of circuitry sections, the freeze controller being configured to generate the plurality of control signals to cause each of the plurality of circuitry sections to enter or exit the system wide freeze mode while limiting peak transient current provided by the power supply circuitry to the plurality of circuitry sections to below a predetermined value.

2. The power distribution control system of claim 1, wherein at least one of the plurality of circuitry sections is coupled to the first output line and is at least partially powered by the first supply voltage.

3. The power distribution control system of claim 2, wherein the power supply circuitry further provides a second supply voltage on a second output line, and wherein at least one of the plurality of circuitry sections is coupled to the second output line and is at least partially powered by the second supply voltage.

4. The power distribution control system of claim 1, wherein while in the system wide freeze mode, the plurality of control signals which hold the plurality of circuitry sections inactive include a plurality of control signals provided by the freeze controller to each of the plurality of circuitry sections.

5. The power distribution control system of claim 1, wherein the freeze controller further includes a control signal generator, and wherein the freeze controller receives a freeze control input and, based upon the freeze control input, the control signal generator generates the plurality of control signals to accordingly either enter each of the plurality of circuitry sections into the system wide freeze mode independently of others of the plurality of circuitry sections, or to exit each of the plurality of circuitry sections out of the system wide freeze mode independently of others of the plurality of circuitry sections, in order to limit peak transient current provided by the power supply circuitry to the plurality of circuitry sections.

6. The power distribution control system of claim 5, and further comprising sensing circuitry coupled to the power supply circuitry and configured to sense a current or a voltage provided by the power supply circuitry, the sensing circuitry generating a sensed output signal indicative of the sensed current or voltage provided by the power supply circuitry, wherein in response to the freeze control input the control signal generator generates the plurality of control signals based upon the sensed output signal in order to limit peak transient current provided by the power supply circuitry.

7. The power distribution control system of claim 5, wherein the freeze controller further comprises a timing circuit coupled to the control signal generator, wherein in response to the freeze control input, the timing circuit controls the control signal generator to sequentially enter each of the plurality of circuitry sections into the system wide freeze mode or to sequentially exit each of the plurality of circuitry sections out of the system wide freeze mode in order to limit peak transient current provided by the power supply circuit.

8. The power distribution control system of claim 7, wherein the timing circuit includes a state machine.

9. The power distribution control system of claim 5, wherein each of the plurality of circuitry sections further includes an acknowledge generating circuit, wherein the acknowledge generating circuit of each particular circuitry section generates an acknowledge signal once the particular circuitry section is entered into or exited out of the system wide sleep mode, wherein the freeze controller further includes an acknowledge receiving circuit coupled to the acknowledge generating circuit of each of the plurality of circuitry sections, and wherein the freeze controller controls the control signal generator to enter or exit a second of the plurality of circuitry sections into or out of the system wide sleep mode only after a first of the plurality of circuitry sections has acknowledged that it has entered or exited the system wide sleep mode.

10. A method of entering or exiting a circuitry system, including a plurality of circuitry sections, into or out of a system wide freeze mode, the method comprising:
providing at least one supply voltage from a power supply coupled to each of the plurality of circuitry sections, wherein while in the system wide freeze mode, each of the plurality of circuitry sections is held inactive by a corresponding one of a plurality of control signals, and wherein when each of the plurality of circuitry sections has been released from the system wide freeze mode, then all of the plurality of circuitry sections are powered by the power supply circuitry;
generating from a freeze controller a plurality of control signals provided to each of the plurality of circuitry sections, the control signal provided to each particular circuitry section causing the particular circuitry section to enter or exit the system wide freeze mode independently of others of the plurality of circuitry sections; and
controlling the generation of the plurality of control signals by the freeze controller in order to enter each of the plurality of circuitry sections into the system wide freeze mode or to exit each of the plurality of circuitry sections from the system wide freeze mode while limiting peak transient current provided by the power supply to the plurality of circuitry sections to below a predetermined value.

11. The method of claim 10, wherein while in the system wide freeze mode, the plurality of control signals which hold all of the plurality of circuitry sections inactive include a plurality of reset signals provided by the freeze controller to each of the plurality of circuitry sections.

12. The method of claim 10, and further comprising:
receiving at the freeze controller a freeze control input; and
generating from a control signal generator of the freeze controller, in response to the freeze control input, the plurality of control signals to accordingly either enter each of the plurality of circuitry sections into the system wide freeze mode independently of others of the plurality of circuitry sections, or to exit each of the plurality of circuitry sections out of the system wide freeze mode independently others of the plurality of circuitry sections in order to limit peak transient current provided by the power supply circuitry to the plurality of circuitry sections.

13. The method of claim 12, and further comprising:
sensing a current or a voltage provided by the power supply circuitry and generating in response a sensed output signal indicative of the sensed current or voltage provided by the power supply circuitry; and
wherein generating the plurality of control signals from the control signal generator further comprises generating the plurality of control signals based upon the sensed output signal to enter each of the plurality of circuitry sections into, or exit each of the plurality of circuitry sections out of, the system wide freeze mode independently of others of the plurality of circuitry sections in order to limit peak transient current provided by the power supply circuitry.

14. The method of claim 12, and further comprising:
generating from a timing circuit, in response to the freeze control input, timing control signals to control the control signal generator to sequentially enter each of the plurality of circuitry sections into the system wide freeze mode, or to sequentially exit each of the plurality of circuitry sections out of the system wide the freeze mode, in order to limit peak transient current provided by the power supply circuit; and
wherein generating the plurality of control signals from the control signal generator further comprises generating the plurality of control signals based upon the timing control signals to sequentially enter or exit each of the plurality of circuitry sections into or out of the system wide freeze mode in order to limit peak transient current provided by the power supply circuit.

15. The method of claim 14, wherein generating the timing control signals from the timing circuit further comprises generating the timing control signals using a state machine.

16. The method of claim 12, wherein each of the plurality of circuitry sections includes an acknowledge generating circuit which generates an acknowledge signal, and wherein the freeze controller further includes an acknowledge receiving circuit coupled to the acknowledge generating circuit of each of the plurality of circuitry sections, the method further comprising:
generating a first of the plurality of control signals from the control signal generator to enter or exit a first of the plurality of circuitry sections into or out of the system wide sleep mode;
generating an acknowledge signal, from the acknowledge generating circuit of the first of the plurality of circuitry sections, once the first of the plurality of circuitry sections has entered into or exited out of the system wide sleep mode;
receiving the acknowledge signal, from the acknowledge generating circuit of the first of the plurality of circuitry sections, at the acknowledge receiving circuit of the freeze controller; and
generating a second of the plurality of control signals from the control signal generator to enter or exit a second of the plurality of circuitry sections into or out of the system wide sleep mode only after receiving the acknowledge signal from the acknowledge generating circuit of the first of the plurality of circuitry sections.
